(19) United States
(12) Patent Application Publication
(10) Pub. No.: US 2023/0240265 A1
(43) Pub. Date: Aug. 3, 2023

(54) Safe and Durable Pet Chews

(71) Applicant: CHEWS HAPPINESS, Boulder, CO (US)

(72) Inventors: Tavor WHITE, Boulder, CO (US); Nidup TSHERING, Thimphu (BT)

(21) Appl. No.: 17/736,041

(22) Filed: May 3, 2022

Related U.S. Application Data
(60) Provisional application No. 63/306,384, filed on Feb. 3, 2022.

(51) Int. Cl. A01K 15/02; A23K 10/20; A23K 20/147; A23K 20/189; A23K 10/30

(52) U.S. Cl. CPC A01K 15/026; A23K 10/20; A23K 20/147; A23K 20/189; A23K 10/30

(57) ABSTRACT

Pet chews comprising at least 50% by weight dried cheese powder, gelatin, and microencapsulated enzymes evenly distributed throughout the pet chew are characterized by a percent digestive degradation in the gastric phase of at least 50% and a Shore D hardness of at least 65, thereby providing a unique combination of durability and digestive degradability. Further, under compressive loads, the chews crumble into dull pieces, rather than sharp fragments capable of causing mouth and intestinal tract lacerations.

### CROSS-REFERENCE TO RELATED APPLICATIONS

This application claims the benefit of and priority to U.S. Provisional Patent Application No. 63/306,384, filed Feb. 3, 2022, which is hereby incorporated by reference in its entirety.

### BACKGROUND

Chewing is essential to dogs, and they benefit from it in a variety of ways, including enhanced oral health and satisfying psychological needs. Consequently, dog guardians experience a determined need to provide durable chews for long-lasting well-being.

However, many dog chew products are not safe for dogs. Many products on the market are not very digestibly degradable through the animals' digestive tracts. For some products on the market, such as most rawhide-based dog chews, potentially dangerous chemicals (e.g., bleach) are used to process the product and can leach out when a dog chews on them. Also, rawhide, which is itself not very digestibly degradable, suffers from an additional digestive system obstruction hazard; the products can expand once consumed by the animal.

Many products, including actual bones, often fragment into sharp shards when chewed, creating a gum, throat, and digestive tract lesion/laceration risk. These products can also pose severe choking hazards to animals chewing on them.

The few products on the market that are safer, are typically not nearly strong enough to withstand dogs' bite forces for any significant length of time and do not last very long: perhaps not longer than a few minutes at a maximum for a large (>60 lb.) dog.

Creating a soft product does not solve the safety problem, as many soft dog chews are still not easily digestibly degradable, meaning that they represent a significant digestive obstruction risk for the animals. Soft dog chews do not solve the longevity problem either, as they do not typically last very long.

Examples of attempts to improve pet chew-related technologies are described, for example, in U.S. Patent Appl. Pub. Nos. US2006/0105025, US2007/0148104, US2011/0183036, US2011/0244090, US2013/0266696, US2013/0266712, US2017/0251699 and US2017/0273336, U.S. Pat. Nos. 5,476,069, 6,601,539 and 8,697,174, International Patent Pub. Nos. WO 2020/048093 and WO 2021/216432, and Chinese Patent Appl. Pub. No. CN102532569. However, pet chews that combine enhanced fragmentation and gastrointestinal obstruction safety, superior ability to withstand high compressive forces, and attractive flavors do not exist.

### SUMMARY

The present invention generally relates to safe and durable pet chews. The pet chews exhibit high digestible degradability due to at least partial dissolution at 39 degrees Celsius—the body temperature of a canine. This digestible degradability ensures that the chews break apart into small pieces in an animal's digestive tract, dramatically reducing the risk of choking and physical obstruction. The chews also withstand high compressive loads and exhibit high hardness enabling long duration chewing. When compressed to failure, they crumble into dull pieces rather than break into sharp pieces, or shards. Resultantly, they provide an extended chew time with diminished/eliminated risk of lesions/lacerations to an animal's mouth and internal organs.

In an aspect, a pet chew comprises (i) at least 50% by weight dried cheese powder, (ii) gelatin, and (iii) microencapsulated enzymes, wherein (i)-(iii) are dispersed throughout the pet chew. For example, (i)-(iii) may be mixed together, heterogeneously distributed throughout the pet chew, homogeneously distributed throughout the pet chew, and/or evenly distributed in terms of concentration throughout the pet chew.

In an embodiment, a pet chew is characterized by a percent digestive degradation (PDD) in the gastric phase of at least 50%, or at least 55% or at least 60%, or at least 65%, or at least 70%, or at least 75%, or at least 80%, or at least 85%, or at least 90%. In an embodiment, a pet chew is characterized by a percent digestive degradation (PDD) in the gastric phase between 50% and 95%, or between 55% and 95%, or between 60% and 95%, or between 65% and 95%, or between 70% and 90%, or between 75% and 95%, or between 80% and 95%, or between 85% and 95%.

In an embodiment, a pet chew is characterized by a Shore D hardness of at least 65, or at least 68, or at least 70, or at least 72. In an embodiment, a pet chew is characterized by a Shore D hardness between 65 and 75, or between 68 and 72.

In an embodiment, a pet chew is characterized by a compressive load failure point between 50 KN and 140 KN, or between 65 KN and 135 KN, or between 80 KN and 120 KN.

In an embodiment, a pet chew is characterized by a chew safety index (CSI) greater than or equal to 3.5, or 4.5, or 5.5. or 7.5, or 11.5, or 13.5, or 15.5, or 17.5.

In an embodiment, a pet chew has a density between 1.00 g/cc and 1.5 g/cc, or between 1.05 g/cc and 1.40 g/cc, or between 1.10 g/cc and 1.35 g/cc, or between 1.15 g/cc and 1.30 g/cc.

In an embodiment, a pet chew comprises crosslinked casein.

In an embodiment, a pet chew comprises dried cheese powder present in a concentration or at least 60% by weight, or between 50% and 75% by weight or between 60% and 75% by weight.

In an embodiment, a pet chew comprises edible fiber, such as, but not limited to, an edible fiber from a source such as pumpkin, rice husk, or combinations thereof. In an embodiment, the edible fiber in a pet chew is present in a concentration of at least 0.75% by weight.

In an embodiment, a pet chew comprises pumpkin, where the pumpkin is present in a concentration between 5% and 15% by weight, or between 10% and 15% by weight, or at least 10% by weight.

In an embodiment, a pet chew comprises a gum.

In an embodiment, a pet chew does not contain a plasticizer. In an embodiment, a pet chew comprises a plasticizer.

In an embodiment, microencapsulated enzymes are digestive enzymes, such as, but not limited to, protease enzymes, lipase enzymes, or a combination thereof. In an embodiment, microencapsulated enzymes are produced by a fungus selected from the group consisting of Aspergillus oryzae, Aspergillus niger, and combinations thereof.

In an embodiment, a pet chew has a final moisture content, after drying, between 10% and 15%. In an embodiment, a pet chew has a final moisture content, after drying, of not more than 15% by weight.

In an embodiment, gelatin is present in a concentration between 10% and 40% by weight, or between 15% and 30% by weight, or between 20% and 25% by weight.

In an embodiment, a pet chew is formed as a three-dimensional object, such as, but not limited to, a three-dimensional object in the shape of a bone. In an embodiment a pet chew has dimensions greater than or equal to 3 cm×1 cm×0.5 cm, or greater than or equal to 6 cm×2 cm×1 cm, or greater than or equal to 10 cm×4 cm×2 cm.

### BRIEF DESCRIPTION OF THE DRAWINGS

Illustrative embodiments of the present invention are described in detail below with reference to the attached drawings.

FIG. 1, Production Process Flow Diagram.

FIG. 2, Mean Percent Increase PDD-gastric from 7.5% Pumpkin Baseline.

FIG. 3, PDD-gastric Performance as a Function of Gelatin Concentration.

FIG. 4. PDD-gastric Performance as a Function of Cheese Concentration.

FIG. 5. CLFP Performance as a Function of Gelatin Concentration.

FIG. 6. CLFP*SDH/100 vs. Weight Normalized Chew Time.

FIG. 7, PDD-gastric and CWNDT for Matrices with 1% Gum and 5% Pectin as a Function of Rice Husk Concentration.

FIG. 8. PDD-gastric and CWNDT for Matrices with and without Rice Husk as a Function of Citric Acid Concentration.

FIG. 9. Enzyme Concentration vs. PDD-gastric.

FIG. 10. Enzyme Concentration vs. CLFP.

FIG. 11. Enzyme Concentration vs. Weight Normalized Chew Time.

FIG. 12. Processing Time and Temperature Effects on PDD-gastric.

FIG. 13. Processing Time and Temperature Effects on CLFP.

FIG. 14. PDD-gastric Performance Across Ten Chew Categories Tested.

FIG. 15. Safety (Chew Safety Index, CSI) vs. Durability (Chew Durability Proxy, CDP) across 31 out of the 32 Chews Tested.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, “pet chew”, “dog chew”, and “animal chew” are used interchangeably to describe an edible product that is not fully consumed for at least 15 minutes when chewed by a dog having a weight-to-weight ratio relative to the pet chew of 223 or less (Le., dog weight:pet chew weight≤223). A pet chew differs from a pet treat in that a pet treat is consumed by an animal quickly, typically in less than two minutes.

As used herein, “weight percent”, “percent by weight” or “wt %” is calculated as the weight of a component divided by the total weight of all components other than water multiplied by 100.

As used herein, a “crosslinker” or “crosslinking agent” is a chemical moiety that covalently or ionically joins nearby molecules. In an embodiment, a crosslinking agent for a pet chew is transglutaminase (TG).

Microencapsulated enzymes useful in the disclosed pet chews are microencapsulated digestive enzymes, which break down the major components of food. For example, protease enzymes break down protein, lipase enzymes break down fat, and carbohydrase enzymes break down carbohydrates. In an embodiment, digestive enzymes are present in the fermentation products of fungi within the Aspergillus genus, such as Aspergillus oryzae and Aspergillus niger. Generally, the microencapsulation material coating the enzymes is an oil that solidifies at room temperature (e.g., palm oil, coconut oil, or combinations thereof) applied through a spray drying process.

In an embodiment, the invention involves combining a source of protein and fat, such as cheese, gelatin, an edible acid such as citric acid, a source of fiber such as pumpkin, enzymes, flavors and ancillary ingredients (antioxidants and preservatives) to form an Advanced Composite Material useful as a dog chew. The Advanced Composite Materials disclosed herein are exemplified by their high strength and are designed with two or more materials with unique properties, such as reinforcing edible fibers, which are combined to provide an extremely durable, but highly digestibly degradable material that is safe for dogs to consume.

As disclosed hereinafter, the pet chew formulation is sensitive to the concentration of ingredients. Too much of one will cause the pet chew to be too soft or too weak. Too little and digestible degradability suffers. In addition, process conditions, such as temperature and heating time, affect chew properties. Too much heat and/or time and the product will not be highly digestibly degradable, not durable, or both.

TABLE 1
Pet Chew Components and Their Functions.

| | | Concen- |
|---|---|---|
| Ingredient Type | | tration |
| and/or | | Range |
| Examples | Function | (wt. %) |
| Granulated, Dried Cheese or | Material backbone and protein/ | 20-75% |
| Cheese Powder | fat source | |
| Gelatin | Binding agent that disintegrates | 10-40% |
| | upon exposure to temperatures | (250 |
| | >35° C. in wet environments | Bloom) |
| Source of Fiber, such as | Reinforcing edible fiber | 5-15% |
| Dried Pumpkin, Natural | | |
| Gums, Pectin, or Rice Husk | | |
| Bone broth, Egg shell | Thickening agent | 5-10% |
| Flavor (e.g., Chicken, Fish, | Flavor | 0-15% |
| Peanut, Peanut Powder, | | |
| yogurt, etc.) | | |
| Honey, Psyllium Husks, | Binding Agent | 0-10% |
| Xanthan Gum, Guar Gum, | | |
| Chia Seeds, Flax Seeds, or | | |
| another binding agent | | |
| Edible Acid, such as Citric | Further removal of colloidal | 0.2-2.25% |
| Acid | calcium phosphate (believed to | |
| | be Ca₃(PO₄)₂) remaining in the | |
| | cheese (from the original milk), | |
| | freeing casein micelles, | |
| | Dissolution of micelles allowing | |
| | casein chains to crosslink, | |
| | strengthening the chew material. | |
| Microencapsulated Enzymes | Assist in the dissolution of the | 0.01-0.5% |
| (e.g., protease & lipase) | chew material inside the canine | |
| | digestive tract | |
| Natural antioxidants, | Antioxidants, preservatives, and | 0-2% |
| preservatives, and flavors | natural flavors | |
| such as cultured milk | | |
| powder, Mixed Tocopherols, | | |
| and Rosemary Extract | | |
| Humectant such as Glycerin | Plasticizer | 0-5% |
| Water | Solvent | 5-25% |

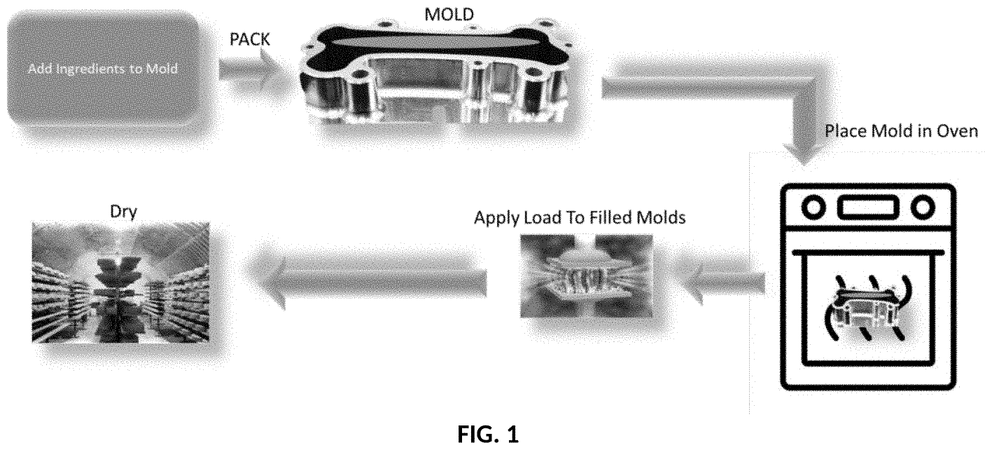

FIG. 1 shows a production process flow diagram. Dry components are mixed, water is added, and the wet mixture is then placed into shaped molds, baked at 80-120° C. for 30-120 min and compressed with an applied load of 250-10,000 lbs. force. The resulting matrix is then dried.

Animal Chew Safety & Durability Metrics

Metrics employed to assess safety and durability of animal chews are described below, where the following abbreviations are used: CDP, chew durability proxy. CLFP, compressive load failure point. CLPS, compressive load piece state. CSI, chew safety index. CWNDCT, Calculated Weight Normalized Dog Chew Time. DPS, digestive piece state. PDD, percent digestive degradation. SDH, Shore D hardness.

Percent Digestive Degradation (PDD) was used to determine gastrointestinal obstruction risk. Dog chews that are swallowed, either in whole or in part, should degrade quickly in the canine digestive system to prevent potentially dangerous obstructions. Using the protocol outlined in Timothy J. Bowser, Charles I. Abramson and Dwayne Bennett, 2006 tow-cost in vitro Screening Method for Digestibility of Pet Chews', American Journal of Animal and Veterinary Sciences 1 (2): 23-26 in-vitro canine digestion tests were conducted in triplicate on one cm cubes of various dog chew product formulations. It was determined that chews were generally much less susceptible to degradation during the gastric phase of digestion. Therefore, this phase was used for primary screening. For those chews that performed well in the gastric phase, the chews were tested in an in-vitro intestinal phase of digestion to verify chew safety. Although in a dog's actual digestive tract anything swallowed would have to first move through the gastric phase prior to reaching the small intestine phase, fresh 1 cm^3 chew pieces were used for each phase to represent a worst-case scenario, representing the potential for a large piece to make it through the gastric phase and into the small intestine phase.

After treatment for five hours, for the simulated gastric phase, and 18 hours, for the in-vitro small intestine phase, samples were washed and then were placed in a dryer at 38-40° C. and left to dry for 48 hours or until weight change over time was negligible. The final mass of the sample was taken as the mass of the heaviest remaining dried particle for each sample. After a determination of the final mass of the sample, the Percent Digestive Degradation of each sample was calculated according to the formula:

PDD=(1−Fm/Im)*100

where Fm=final mass and Im=initial mass.

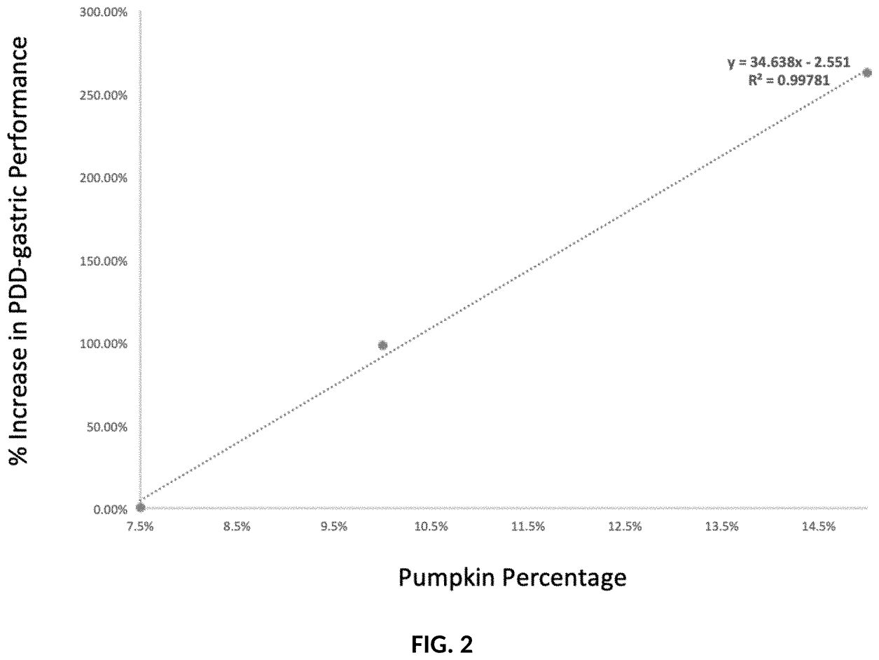

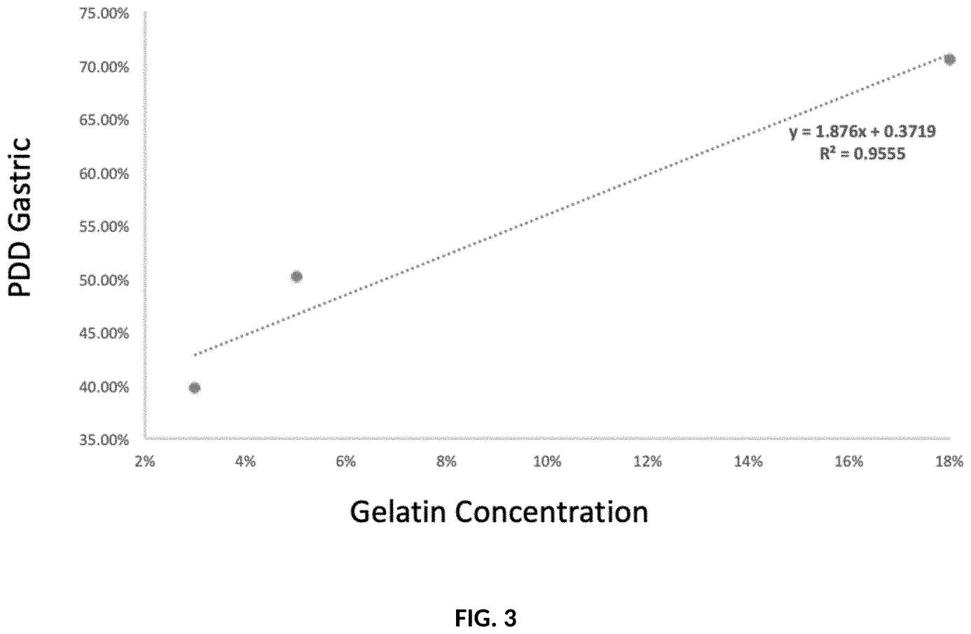

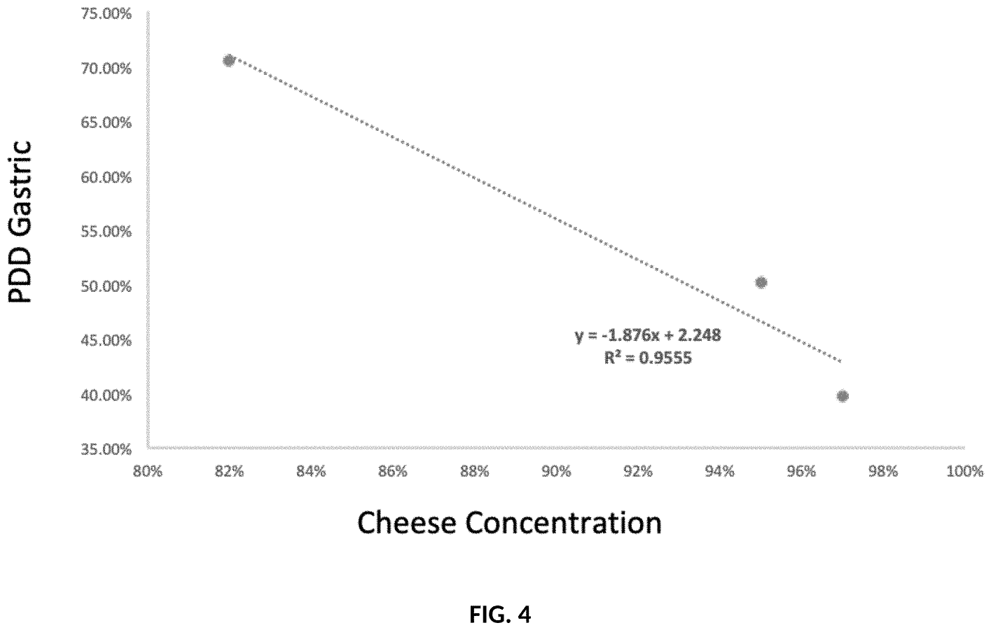

FIG. 2 shows mean percent increase in PDD-gastric as a function of pumpkin concentration in a pet chew having a formulation disclosed herein. As pumpkin concentration increases from a baseline of 7.5 wt. %/pumpkin to 15 wt. %, PDD-gastric performance improves linearly by more than 250%. Likewise, as gelatin concentration increases in a pet chew having a formulation disclosed herein, PDD-gastric increases linearly, as shown in FIG. 3. On the other hand, when cheese concentration increases hi a pet chew having a formulation disclosed herein from 82 wt. % to 97 wt. %, such as when cheese replaces pumpkin or gelatin, PDD-gastric decreases linearly, as shown in FIG. 4.

Digestive Piece State (DPS)-gastric/intestinal is a determination of how a chew disintegrates during digestion (versus how completely it does so). Reported as one of four possible ranking numbers: 0.5, 2, 5, 10.

After each sample was subjected to the in-vitro digestion test, described above, the pieces remaining were evaluated across four Piece State Categories. The closer a piece state is to the powder category, the safer it is for a canine to consume, as smaller pieces do not pose the obstruction risk that larger ones do, The opposite is true for pieces that are closer to the solid block category. These pieces represent a significant obstruction risk, as they do not break down in the canine digestive tract.

Although highly correlated to PDD, DPS evaluates the relative size of the particles remaining after the in-vitro digestion tests, adding an important verification dimension to the PDD measure. In addition, evaluating DPS as a worst-case, is not highly correlated with PDD.

DPS is scored as follows:

10—Solid Block: Original specimen is recognizable with little, if any change.

5—Large Piece(s) somewhat degraded: Original specimen is recognizable, but a significant number of pieces have broken off, or the original specimen has broken into multiple large pieces.

2—Small Pieces: Original specimen is not recognizable and has broken into multiple small pieces, the heaviest of which has dimensions that can be accurately measured (with a digital caliper).

0.5—Powder: All that is left is powder.

Compressive Load Failure Point Piece State (CLPS) represents a determination of how a chew fragments upon exposure to a compressive load. It is reported as one of three possible ranking numbers: 1, 5, 10.

Compressive load failure point tests were conducted to determine a chew's durability (see next section). After this test was performed, the pieces were evaluated to determine how safely a chew fragments. If it breaks into sharp shards, the chew was determined to be unsafe. If it breaks into relatively dull or blunt pieces, it was determined to be safer.

10—Sharp Shards: Pieces fragment (and/or crack in such a way that with continued load they will fragment) into multiple sharp pieces that tend not to crumble and are potentially capable of causing injury upon chewing, swallowing, or movement through the digestive tract.

5—Moderately Sharp Pieces: Pieces fragment (and/or crack in such a way that with continued load they will fragment) into pieces that are not dull, do not crumble, or only slightly crumble, with edges that can pose a risk.

1—Dull Pieces: Pieces either do not fragment, or fragment into dull pieces that tend to crumble representing a much lower risk of causing injury upon chewing, swallowing, or movement through the digestive tract.

Piece Volume Change (PVC) is the volume change recorded as a percent of the original piece volume according to the formula:

Fhv=final remaining heaviest piece volume, mm³

Iv=initial volume, mm³

PVC=(Fhv/Iv−1)×100%.

For specimens with DPS=0.5 (powder), there was no heaviest piece to measure. So, PVC is set at −100% to reflect the effective disappearance of volume.

Chew Safety Index (CSI) is a composite metric that summarizes a chew's potential obstruction and lesion/laceration risk. CSI is calculated as follows:

Chew Safety Index (CSI)=100(PPD−gastric MIN)×(PDD−intestinal MIN)×(−PVC−gastric MAX)×(−PVC−intestine MAX))/((DPS−gastric MAX)×(CLPS−MAX))

Dog Chew Durability Metrics

Compressive Load Failure Point (CLFP) testing is a technique for determining the performance of materials under a compressive load. Compression tests using a modified version of the point-load strength test described in E. Brach and J. A. Franklin, 1972, International Journal of Rock Mechanics and Mining Sciences & Geomechanics Abstracts, 9(6): 669-676. doi: https://doi.org/10.1016/0148-9062(72)90030-7 were conducted by setting a chew sample between two plates and then applying a force to the sample until failure using a calibrated compression device.

The apparatus comprises a rigid loading frame and a loading measuring system. It utilizes a hydraulic pressure gauge calibrated by a digital load meter. The device is flexible to allow for specimens of various sizes to be tested.

Rather than testing standard-sized medallions and measuring the strength of the chew material without factoring how size and shape affect a chew in use, the load was applied across the length of each chew as is to emulate the load direction typically applied by a canine. Each sample was then compressed to failure. As each sample was compressed, deformation versus the applied load was recorded. The failure point was determined to be the compressive bad at which the chew specimen cracked or was otherwise irreversibly deformed.

To approximate how a chew starts to break down as a canine wets it with its saliva (through licking, etc.), each sample was wetted for five minutes in water at 39 degrees C. (the body temperature of a dog) prior to applying the compressive bad. In this manner, it was possible to reasonably emulate pre-digestion processing or chew softening that may occur in a dog's mouth.

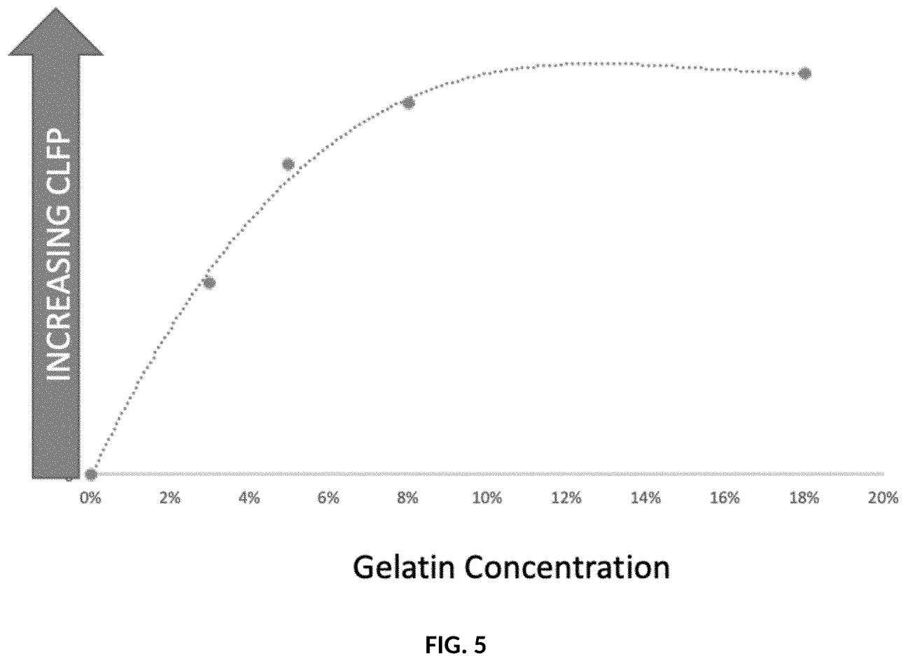

A graph of CLFP as a function of gelatin concentration is shown in FIG. 5 for a pet chew having a formulation as disclosed herein. CLFP and gelatin concentration were found to be directly proportional until a maximum CLFP was reached at about 8 wt. % gelatin.

Shore D Hardness (SDH)

A Shore D Durometer was used to measure chew material hardness. Shore Hardness is a standardized test using a calibrated device that measures the depth of penetration of a particular indenter in order to rate the hardness of a material. Test methods used to measure Shore D Hardness are ASTM D2240 and ISO 868.

Calculated Weight Normalized Dog Chew Time (CWNDCT)

The ultimate test of a chew's durability is how much chewing time it provides, Of course, chew time can vary among dogs due to such factors as chewing aggressiveness, bite force, dog size, and dog “personality” (e.g., some dogs carry their chews around and only lightly chew for a while prior to more aggressively chewing them).

However, a strong correlation has been found between dog weight and chew time. This makes sense, as a primary determinant of chew time is bite force, of which dog size is a primary factor. Therefore, strong correlations were drawn between weight normalized chew time, chew time normalized for a dog's weight versus that of the median of dogs tested (30 kg), and durability (a combination of Compressive Load Failure Point, and Shore D Hardness), clearly linking durability to chew time.

Chew Durability Proxy (CDP) is a composite metric that summarizes a chew's potential durability. It complements CWNDCT. CDP is calculated as follows:

Chew Durability Proxy (CDP)=(CLFP−MIN)×(SDH−MIN).

Testing Protocol

Chews with various CLFP and SDH measures were provided to fifteen dogs under strict observation to ensure animal safety, Actual chew time was recorded for each chew. Chew time was normalized to the median weight across all fifteen dogs (30 kg) using the following formula:

Weight Normalized Chew Time=(Actual Chew Time)*(Dog Weight/Median Dog Weight).

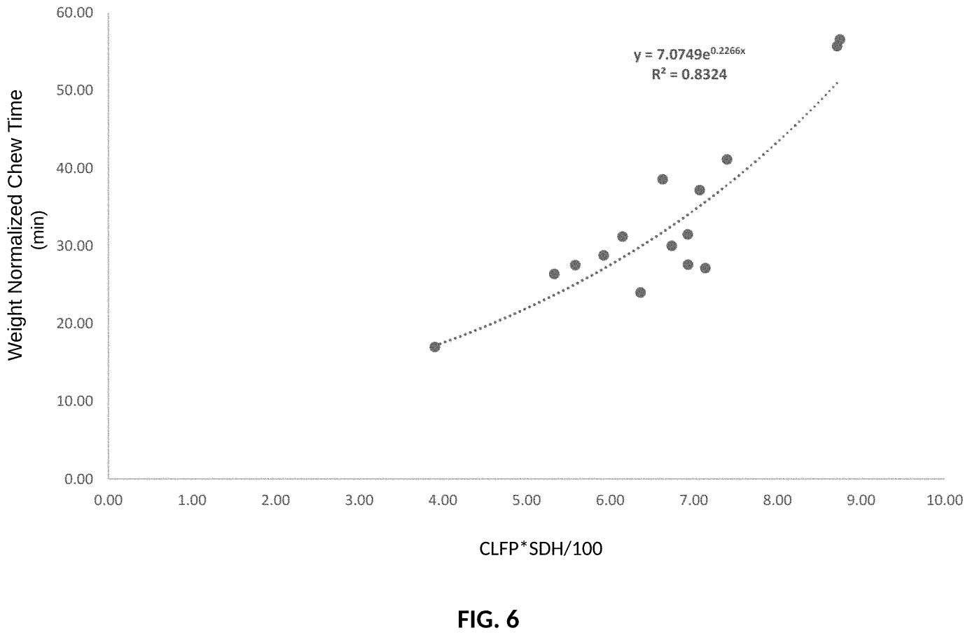

Weight Normalized Chew Time data were then analyzed versus CLFP and SDH. A very strong correlation was obtained, as can be seen in FIG. 6. The correlation equation was then used to determine CWNDCT for any chew where CLFP and SDH is known.

Results

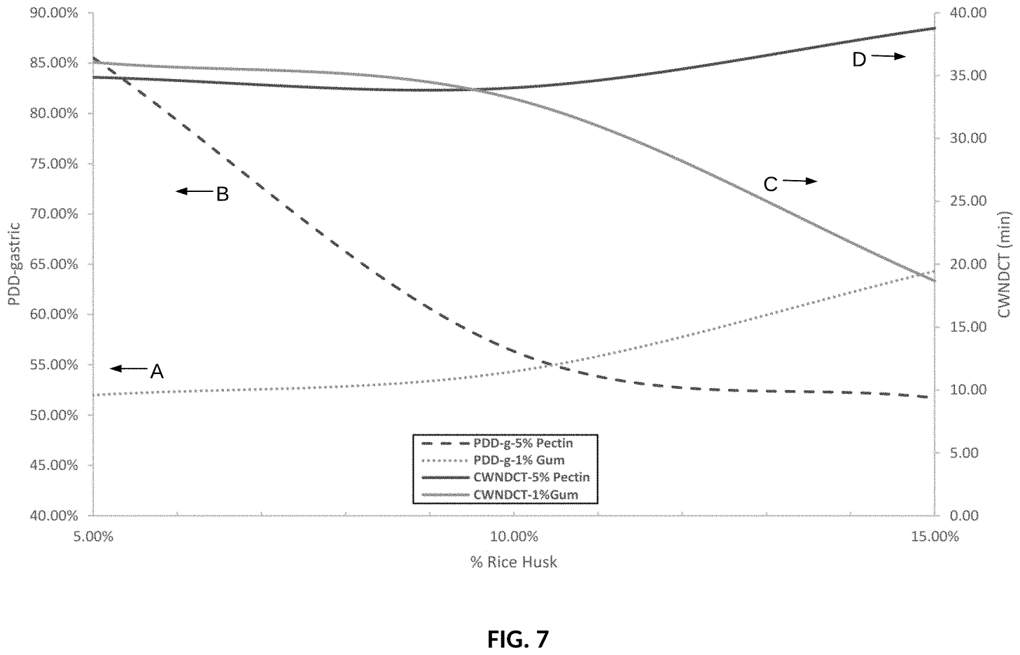

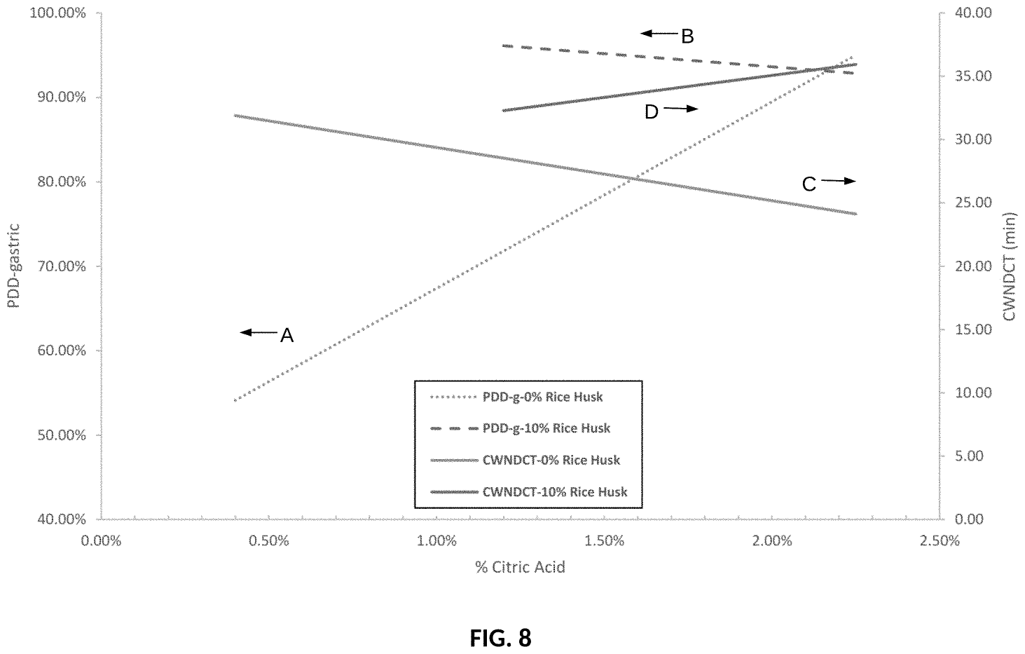

The metrics are sensitive to changes in concentration and to the specific matrix/formulation. For example, as shown in FIG. 7, changing the rice husk concentration has the opposite effect in two different matrices. In a matrix/formulation containing (A) 1% gum, adding rice husk increases digestive performance (PDD-gastric), while in a matrix containing (B) 5% pectin adding rice husk has the opposite effect. Similarly, with (C) 1% gum, CWNDCT reduces as rice husk is added while this metric increases when rice husk is added in the (D) 5% pectin matrix. Likewise, increasing citric acid concentration increases PDD-gastric performance, while reducing CWNDCT with 0% rice husk (A and C), but has the opposite effect with 10% rice husk (B and D) (FIG. 8).

Importantly, for chews formulated according to the present disclosure digestive performance is generally inversely proportional to durability performance (FIG. 7; FIG. 8). Thus, it is difficult to determine a range where a pet chew provides the desired results: high digestive degradability (PDD) and high durability (high CLFP and SDH providing high CWNDT and CDP).

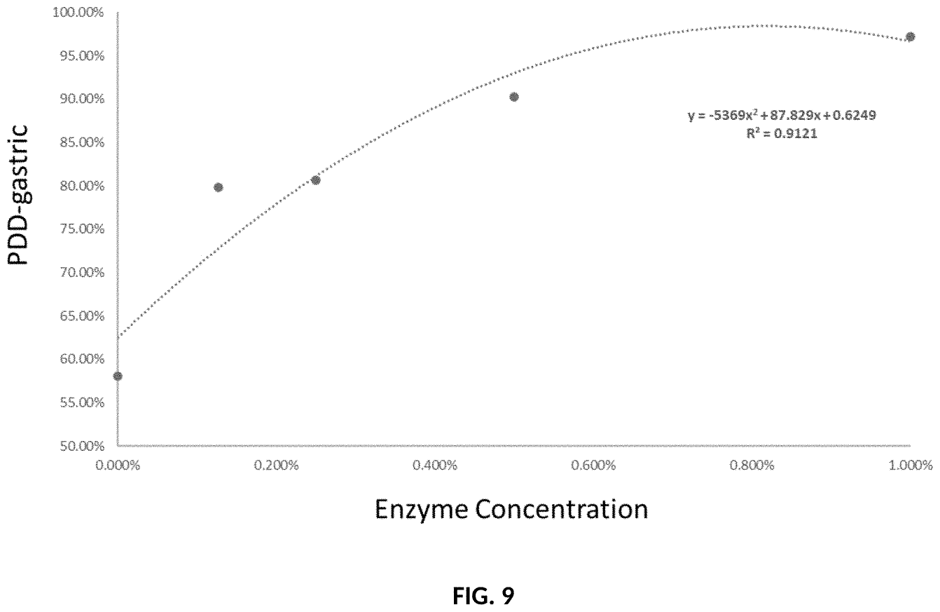

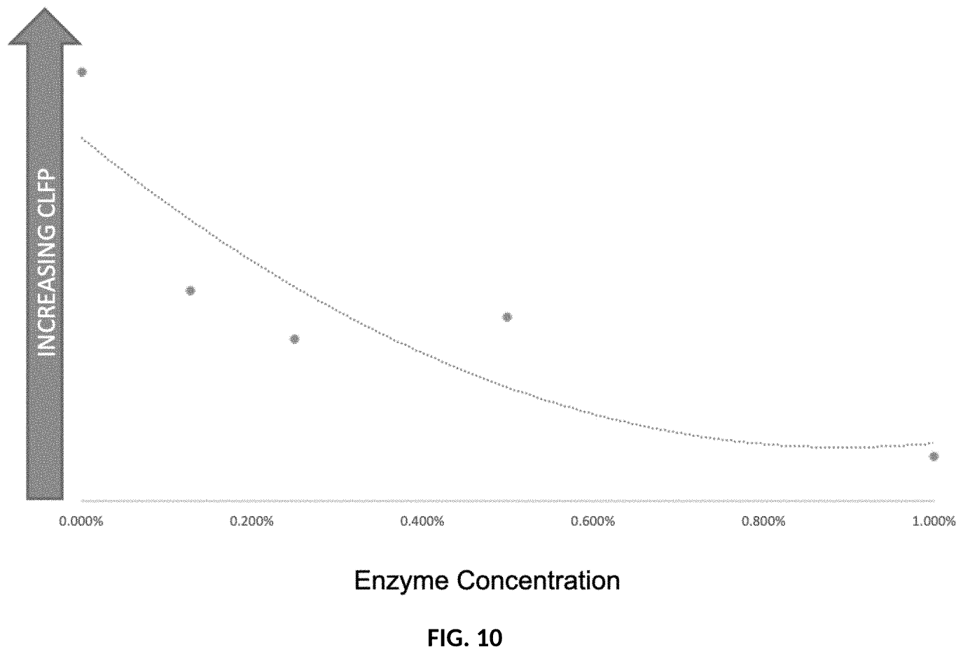

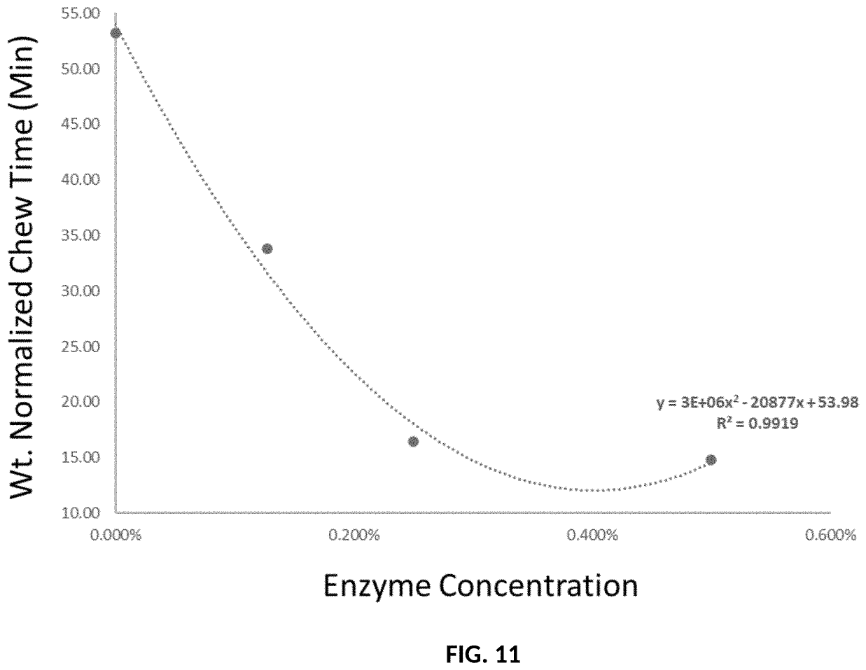

The metrics are also sensitive to changes in microencapsulated enzyme concentration, as can be seen in FIGS. 9-11.

Effect of Changing Processing Conditions

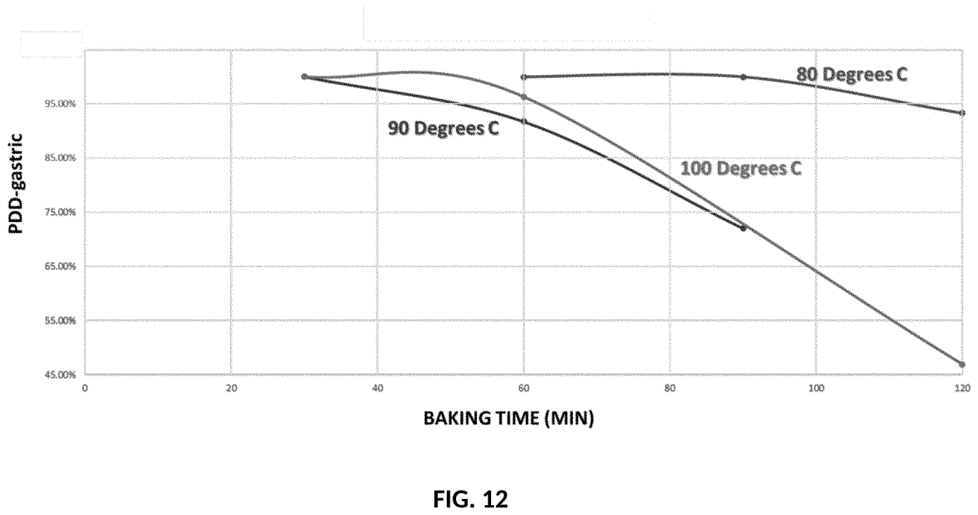

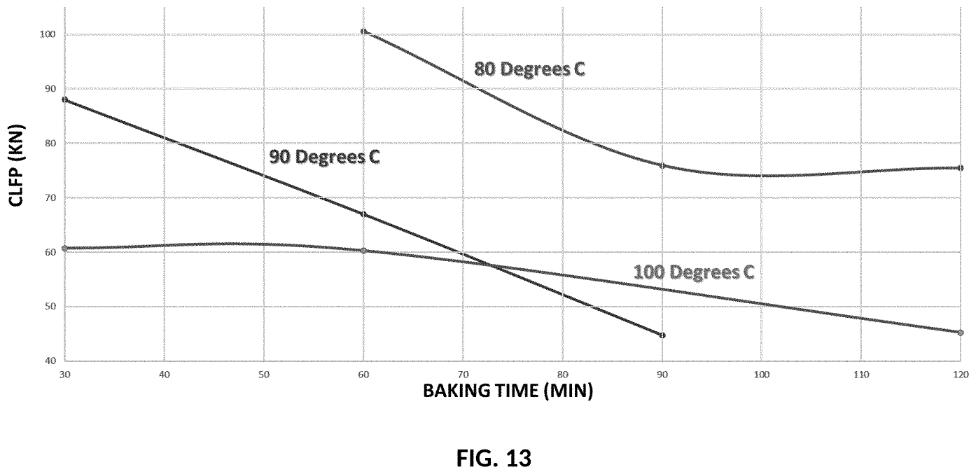

In addition to the metrics being sensitive to specific ingredient concentrations, the pet chew's performance is sensitive to process conditions. The same formulation will result in different product performance with changing process conditions. As shown in FIG. 12 and FIG. 13, changes in baking temperature and time have an effect on digestive performance (PDD-gastric: FIG. 12) and on CLFP (FIG. 13), a major contributor to durability.

Performance of the Disclosed Chews vs. Chews Presently on the Market

A study was conducted on 32 dog chews across ten categories, five safety metrics, and two durability measures. The categories were:
Advanced Composite Material (ACM); Chews which are exemplified by their ability to withstand relatively high compressive loads and which are designed with two or more materials with unique properties (including reinforcing edible fibers) to achieve high durability with high digestive degradability.
Antler (AN): Elk antler.
Bone Alternative (BA): Bone-shaped chews that are not, based on their measured properties, advanced composite materials.
Beef Pizzle (BP): Beef pizzle.
Cheese Chews-Hard (CCH): Chews made from cheese that is hard (Shore Hardness >55.00; see Materials and Methods section),
Cheese Chews-Soft (CCS): Chews made from cheese that is soft (Shore D Hardness <45.00; see Materials and Methods section).
Dental Chews (DC): Chews that emphasize their dental benefits.
Rawhide Alternative (RA): Chews designed as an alternative to rawhide. These chews are in the form of rolls, similar to rawhide rolls.
Rawhide (RH): Chews made from rawhide, including beef hide. Samples tested were rolled rawhide.

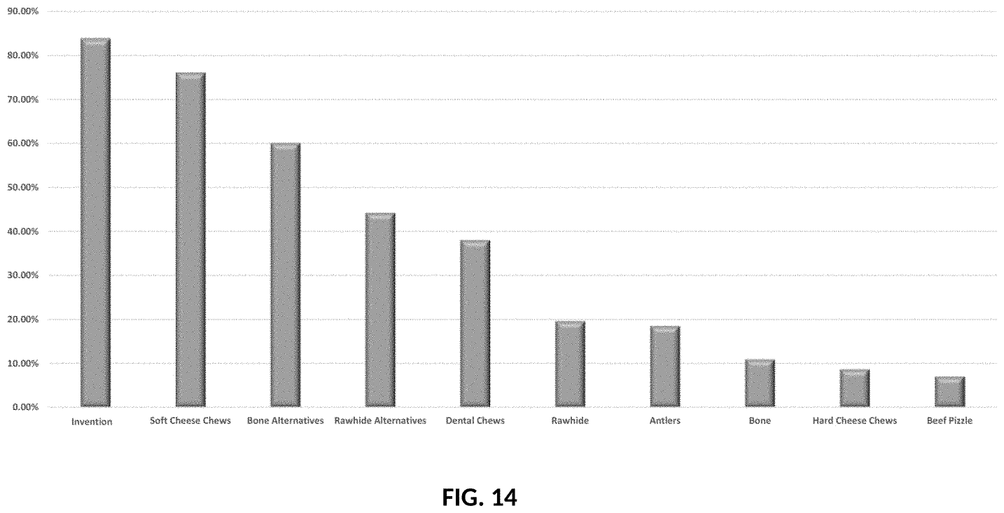

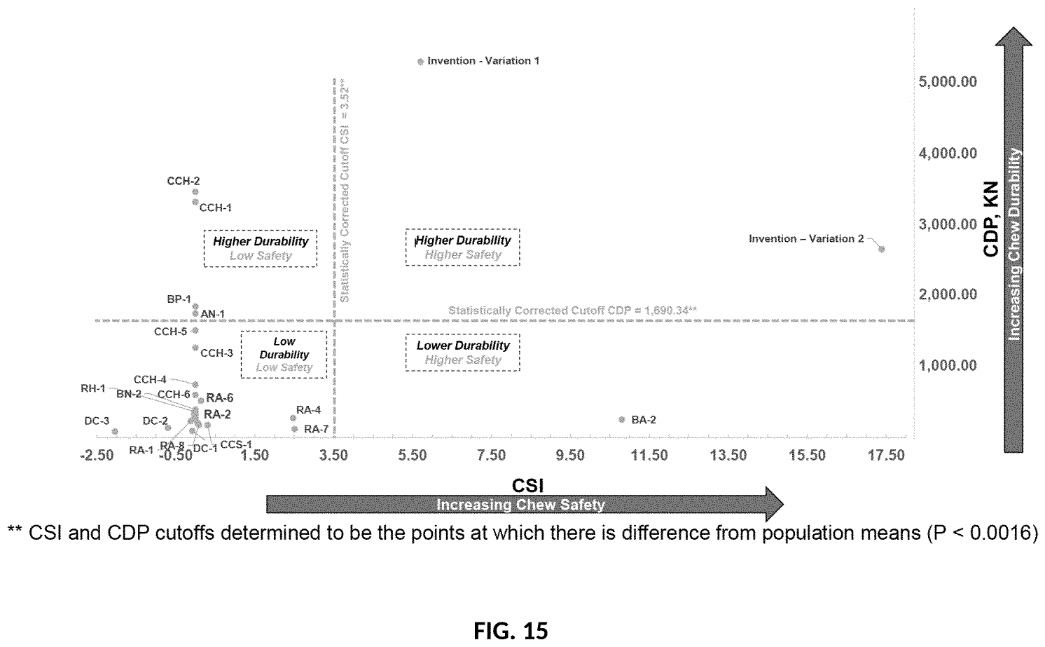

Including a chew of the type disclosed herein having at least 50% by weight dried cheese powder, gelatin, and microencapsulated enzymes evenly distributed throughout, three of the tested chews (9.4%) can be considered safe. Eighteen chews tested (56.25%) claim high digestibility on their labels (or make similar claims), yet none exhibited this consistently. The pet chews disclosed herein tested as having high digestible degradability (FIGS. 14 and 15) and were the only tested chews shown to be both safe and durable (FIG. 15).

TABLE 2
Exemplary Formulations

| Sample | Formulation (Dry | PDD | DPS | | CLFP, | | CWNDCT |
|---|---|---|---|---|---|---|---|
| # | Basis) | (Gastric) | (Gastric) | CLPS | KN | SDH | (Minutes) |
| 1 | CHEESE 56.7%, | 69.5% | 4.8 | 0 | 80 | 68 | 24.3 |
| | GELATIN 21%, | | | | | | |
| | PUMPKIN 10%, | | | | | | |
| | CHICKEN 5%, | | | | | | |
| | HONEY 5%, | | | | | | |
| | ANTIOXIDANTS & | | | | | | |
| | PRESERVATIVES | | | | | | |
| | 1.6%, CITRIC ACID | | | | | | |
| | 0.4%, | | | | | | |
| | MICROENCAPSU- | | | | | | |
| | LATED ENZYMES | | | | | | |
| | 0.3%, | | | | | | |
| 2 | CHEESE 61.9%, | 80.0% | 2.5 | 0 | 118 | 72 | 48.5 |
| | GELATIN 21%, | | | | | | |
| | PUMPKIN 10%, | | | | | | |
| | CHICKEN 5%, | | | | | | |
| | ANTIOXIDANTS & | | | | | | |
| | PRESERVATIVES | | | | | | |
| | 1.6%, CITRIC ACID | | | | | | |
| | 0.4%, | | | | | | |
| | MICROENCAPSU- | | | | | | |
| | LATED ENZYMES | | | | | | |
| | 0.1% | | | | | | |
| 3 | CHEESE 62%, | 58.1% | 5.8 | 5 | 138 | 73 | 69.4 |
| | GELATIN 21%, | | | | | | |
| | PUMPKIN 10%, | | | | | | |
| | CHICKEN 5%, | | | | | | |
| | ANTIOXIDANTS & | | | | | | |
| | PRESERVATIVES | | | | | | |
| | 1.6%, CITRIC ACID | | | | | | |
| | 0.4% | | | | | | |
| 4 | CHEESE 60.1%, | 95.0% | 1.5 | 0 | 82 | 65 | 23.7 |
| | GELATIN 21%, | | | | | | |
| | PUMPKIN 10%, | | | | | | |
| | CHICKEN 5%, | | | | | | |
| | CITRIC ACID 2.3%, | | | | | | |
| | ANTIOXIDANTS & | | | | | | |
| | PRESERVATIVES | | | | | | |
| | 1.6% | | | | | | |
| 5 | CHEESE 46%, | 64.3% | 5.2 | 0 | 67 | 67 | 19.6 |
| | GELATIN 21%, RICE | | | | | | |
| | HUSK 15%, | | | | | | |
| | PUMPKIN 10%, | | | | | | |
| | CHICKEN 5%, | | | | | | |
| | ANTIOXIDANTS & | | | | | | |
| | PRESERVATIVES | | | | | | |
| | 1.6%, GUM 1%, | | | | | | |
| | CITRIC ACID 0.4% | | | | | | |
| 6 | CHEESE 57%, | 52.0% | 6.3 | 0 | 103 | 70 | 36.2 |
| | GELATIN 21%, | | | | | | |
| | PUMPKIN 10%, RICE | | | | | | |
| | HUSK 5%, CHICKEN | | | | | | |
| | 5%, ANTIOXIDANTS | | | | | | |
| | & PRESERVATIVES | | | | | | |
| | 1.6%, GUM 1%, | | | | | | |
| | CITRIC ACID 0.4% | | | | | | |
| 7 | CHEESE 52%, | 86.5% | 2.2 | 5 | 101 | 73.3 | 37.9 |
| | GELATIN 21%, | | | | | | |
| | PUMPKIN 10%, RICE | | | | | | |
| | HUSK 5%, PECTIN | | | | | | |
| | 5%, CHICKEN 5%, | | | | | | |
| | ANTIOXIDANTS & | | | | | | |
| | PRESERVATIVES | | | | | | |
| | 1.6%, CITRIC ACID | | | | | | |
| | 0.4% | | | | | | |
| 8 | CHEESE 42%, | 56.4% | 5.9 | 5 | 99 | 70 | 34.0 |
| | GELATIN 21%, RICE | | | | | | |
| | HUSK 10%, | | | | | | |
| | CHICKEN 10%, | | | | | | |
| | PUMPKIN 10%, | | | | | | |
| | PECTIN 5%, | | | | | | |
| | ANTIOXIDANTS & | | | | | | |
| | PRESERVATIVES | | | | | | |
| | 1.6%, CITRIC ACID | | | | | | |
| | 0.4% | | | | | | |
| 9 | CHEESE 56.5%, | 90.2% | 2.5 | 0 | 116 | 72 | 47.0 |
| | GELATIN 21%, | | | | | | |
| | CHICKEN 10%, | | | | | | |
| | PUMPKIN 10%, | | | | | | |
| | ANTIOXIDANTS & | | | | | | |
| | PRESERVATIVES | | | | | | |
| | 1.6%, | | | | | | |
| | MICROENCAPSU- | | | | | | |
| | LATED ENZYMES | | | | | | |
| | 0.5%, CITRIC ACID | | | | | | |
| | 0.4%, | | | | | | |
| 10 | CHEESE 56.9%, | 80.0% | 2.8 | 0 | 118 | 72 | 48.5 |
| | GELATIN 21%, | | | | | | |
| | CHICKEN 10%, | | | | | | |
| | PUMPKIN 10%, | | | | | | |
| | ANTIOXIDANTS & | | | | | | |
| | PRESERVATIVES | | | | | | |
| | 1.6%, CITRIC ACID | | | | | | |
| | 0.4%, | | | | | | |
| | MICROENCAPSU- | | | | | | |
| | LATED ENZYMES | | | | | | |
| | 0.1% | | | | | | |
| 11 | CHEESE 61%, | 97.2% | 1.2 | 0 | 99 | 68 | 32.5 |
| | GELATIN 21%, | | | | | | |
| | PUMPKIN 10%, | | | | | | |
| | CHICKEN 5%, | | | | | | |
| | ANTIOXIDANTS & | | | | | | |
| | PRESERVATIVES | | | | | | |
| | 1.6%, | | | | | | |
| | MICROENCAPSU- | | | | | | |
| | LATED ENZYMES 1%, | | | | | | |
| | CITRIC ACID 0.4% | | | | | | |
| 12 | CHEESE 52%, | 69.6% | 4.7 | 0 | 100 | 70 | 34.6 |
| | GELATIN 21%, | | | | | | |
| | PUMPKIN 10%, | | | | | | |
| | CHICKEN 5%, RICE | | | | | | |
| | HUSK 5%, | | | | | | |
| | EGGSHELL 5%, | | | | | | |
| | ANTIOXIDANTS & | | | | | | |
| | PRESERVATIVES | | | | | | |
| | 1.6%, GUM 1%, | | | | | | |
| | CITRIC ACID 0.4% | | | | | | |
| 13 | CHEESE 71.1%, | 100% | 0.5 | 0 | 35 | 65 | 11.8 |
| | PUMPKIN 10%, | | | | | | |
| | CHICKEN 5%, | | | | | | |
| | GELATIN 8%, CITRIC | | | | | | |
| | ACID 2.3%, | | | | | | |
| | GLYCERIN 2%, | | | | | | |
| | ANTIOXIDANTS & | | | | | | |
| | PRESERVATIVES | | | | | | |
| | 1.6% | | | | | | |
| 14 | CHEESE 61.9%, | 85.1% | 2.0 | 0 | 52 | 72.5 | 16.5 |
| | GELATIN 21%, | | | | | | |
| | PUMPKIN 10%, FISH | | | | | | |
| | 5%, ANTIOXIDANTS | | | | | | |
| | & PRESERVATIVES | | | | | | |
| | 1.6%, CITRIC ACID | | | | | | |
| | 0.4%, | | | | | | |
| | MICROENCAPSU- | | | | | | |
| | LATED ENZYMES | | | | | | |
| | 0.1% | | | | | | |
| 15 | CHEESE 54.3%, | 81.7 | 2.5 | 0 | 112 | 70.7 | 42.6 |
| | GELATIN 21%, | | | | | | |
| | PUMPKIN 10%, | | | | | | |
| | CHICKEN 5%, RICE | | | | | | |
| | HUSK 5%, YOGURT | | | | | | |
| | 1.7%, | | | | | | |
| | ANTIOXIDANTS & | | | | | | |
| | PRESERVATIVES | | | | | | |
| | 1.6%, GUM 1%, | | | | | | |
| | CITRIC ACID 0.4% | | | | | | |

References:

White, T. The State of Dog Chew Safety & Efficacy: Appraisal of Dog Chew Safety & Efficacy Using In Vitro Digestion, Hardness, & Compressive Load Failure Point Testing. pp. 1-62. Unpublished manuscript, attached as Exhibit A.

Arhant, C., R. Winkelmann, and J. Troxler. 2021. Chewing behaviour in dogs—A survey-based exploratory study. Applied Anm. Behaviour Sci. 241:105372. doi:10.1016/j.applanim.2021.105372.

Gallagher, L. 2013. The effect of dental products and natural chews on canine oral bacteria. Letters in General Microbiology. 1:1-4

Bowser, T. J., C. I. Abramson, and D. Bennett. 2006. Low-cost in vitro Screening Method for Digestibility of Pet Chews. American Journal of Animal and Veterinary Sciences 1(2):23-26. doi:10.3844/ajavsp.2006.23.26.

Luthi, C., and R. Neiger. 1998. Esophageal foreign bodies in dogs: 51 cases (1992-1997). Eur. J. Comp. Gastroenterol. 3:7-11.

He, F., G. Holben, and M. R. C. de Godoy. 2020. Evaluation of selected categories of pet treats using in vitro assay and texture analysis. Transl. Anim. Sci. 4:1023-1030.

Burton A. G., C. T. Talbot, M. S. Kent. 2017. Risk Factors for Death in Dogs Treated for Esophageal Foreign Body Obstruction: A Retrospective Cohort Study of 222 Cases (1998-2017). J Vet Intern Med. 31(6):1686-1690. doi: 10.1111/jvim.14849.

Fernando A. Osorio et al. (2007) Effects of Concentration, Bloom Degree, and pH on Gelatin Melting and Gelling Temperatures Using Small Amplitude Oscillatory Rheology, International Journal of Food Properties, 10:4, 841-851, DOI: 10.1080/10942910601128895

Michael H. Tunick. The science of cheese. ISBN 978-0-19-992230-7. SF271.T86 2014. 637j.3-dc23 2013010729.

Ye R. and Harte F. Casein maps: effect of ethanol, pH, temperature, and CaCl₂ on the particle size of reconstituted casein micelles. J. Dairy Sci. 2013; 96(2)199-805. doi:10.31681ds.2012-5838

Fei He, Grace Holben, and Maria R. C. de Godoy, 2020 ‘Evaluation of selected categories of pet treats using in vitro assay and texture analysis’, American Society of Animal Science

Lindsay Gallagher, The Effect of Dental Products and Natural Chews on Canine Oral Bacteria', 2013 Letters in General Microbiology|VOL 1|

Wendy Brown, ‘Influence of Chewing on Dental Health in Dogs’, Animal Science, University of New England, Armidale, NSW, 2351, Australia

He, F., G. Holben, and M. R. C. de Godoy. 2020. Evaluation of selected categories of pet treats using in vitro assay and texture analysis. Transl. Anim. Sci. 4:1023-1030.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a molecule” includes a plurality of such molecules and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

1. A pet chew comprising:
(i) at least 50% by weight dried cheese powder;
(ii) gelatin;
(iii) microencapsulated digestive enzymes; and
(iv) an edible fiber, wherein (i)-(iv) are ingredients of the pet chew.

2. The pet chew of claim 1, wherein the pet chew is characterized by a percent digestive degradation (PDD) in the gastric phase of at least 50%.

3. The pet chew of claim 1, wherein the pet chew is characterized by a percent digestive degradation (PDD) in the gastric phase between 50% and 100%.

4. The pet chew of claim 1, wherein the pet chew is characterized by a Shore D hardness of at least 65.

5. The pet chew of claim 1, wherein the pet chew is characterized by a Shore D hardness between 65 and 75.

6. The pet chew of claim 1, wherein the pet chew is characterized by a compressive load failure point between 50 KN and 140 KN.

7. The pet chew of claim 1, wherein the pet chew is characterized by a chew safety index (CSI) greater than or equal to 3.5.

8. The pet chew of claim 1, wherein the pet chew has a density between 1.00 g/cc and 1.5 g/cc.

9. The pet chew of claim 1, wherein the pet chew comprises crosslinked casein.

10. The pet chew of claim 1, wherein the dried cheese powder is present in a concentration between 50% and 75% by weight.

11. The pet chew of claim 1, wherein the edible fiber is from a source selected from pumpkin, rice husk, or combinations thereof.

12. The pet chew of claim 11, wherein the edible fiber is present in a concentration of at least 0.75% by weight.

13. The pet chew of claim 1, wherein the edible fiber is from pumpkin.

14. The pet chew of claim 13, wherein the pumpkin is present in a concentration of at least 5% by weight.

15. The pet chew of claim 13, wherein the pumpkin is present in a concentration of between 5% and 15% by weight.

16. (canceled)

17. The pet chew of claim 1, wherein the digestive enzymes are protease enzymes, lipase enzymes, or a combination thereof.

18. The pet chew of claim 1, wherein the microencapsulated enzymes are produced by a fungus selected from the group consisting of Aspergillus oryzae, Aspergillus niger, and combinations thereof.

19. The pet chew of claim 1, wherein the gelatin is present in a concentration between 10% and 40% by weight.

20. The pet chew of claim 1 formed as a three-dimensional object.

21. The pet chew of claim 1, wherein the microencapsulated digestive enzymes are present in a concentration between 0.01% and 0.5% by weight.
